(19) United States
(12) Patent Application Publication
(10) Pub. No.: US 2026/0024034 A1
(43) Pub. Date: Jan. 22, 2026

(54) ARTIFICIAL INTELLIGENCE-BASED (AI-BASED) SYSTEM AND METHOD FOR GENERATING OPTIMISED OPERATION PLANNING AND SCHEDULING OUTPUT

(71) Applicant: SUCHAMA AI PVT. LTD, Bangalore (IN)

(72) Inventors: ANIRUDDH BARANWAL, Raipur (IN); KUNAL CHAWLA, Sunnyvale, CA (US); JITESH KUMAR VASAVADA, Chennai (IN); ALWIN VARGHESE, Kozhikode (IN); PRABHAKAR JHA, Madhubani (IN); SOMA SIDDHARTHA, Hyderabad (IN); SHEKHAR YADAV, Meerut (IN); PRASAD KULKARNI, Pune (IN); AYUSH AGARWAL, Purnea (IN); SANJAY SHEKHAWAT, Bagot (IN); AVINASH GUPTA, Mumbai (IN)

(21) Appl. No.: 19/272,089

(22) Filed: Jul. 17, 2025

(30) Foreign Application Priority Data
Jul. 17, 2024 (IN) 202441054583
Jul. 17, 2025 (IN) 202441054583

(51) Int. Cl. G06Q 10/0631; G06Q 10/0633; G06Q 30/0202

(52) U.S. Cl. CPC G06Q 10/06312; G06Q 10/0633; G06Q 30/0202

(57) ABSTRACT

The present invention discloses an artificial intelligence-based (AI-based) system and method for generating optimised operation planning and scheduling output. The AI-based system obtains at least one of: one or more data explanation videos, one or more process understanding videos, and unconstrained operational planning data, along with one or more prompts as an input. The AI-based system extracts one or more informative image frames and audio data, to train the one or more AI models and generate a planning standard operating procedure (SOP). The AI-based system processes the planning SOP, the constrained operational planning data, and the one or more prompts to generate the optimised operation planning and scheduling output based on an optimised function with a continuous feedback loop in response to at least one of: the one or more prompts, updated planning SOP, and real-time changes in the constrained operational planning data.

### EARLIEST PRIORITY DATE

This application claims priority from an Indian Patent application bearing Patent Application no. 202441054583, filed on 17 Jul. 2025 and titled “ARTIFICIAL INTELLIGENCE-BASED (AI-BASED) SYSTEM AND METHOD FOR GENERATING OPTIMISED OPERATION PLANNING AND SCHEDULING OUTPUT” which itself claims priority to Indian provisional patent application No. 202441054583, filed on 17 Jul. 2024, titled “SYSTEM AND METHOD FOR OPTIMIZED DYNAMIC SUPPLY-CHAIN PLANNING AND PRODUCTION SCHEDULING USING GENERATIVE-AI AND QUANTUM COMPUTING”.

### FIELD OF INVENTION

Embodiments of the present invention relate to artificial intelligence (AI)-enabled enterprise operations and decision support systems, and more particularly, to an artificial intelligence-based (AI-based) system and method for generating optimised operation planning and scheduling output using one or more domain-specific generative artificial intelligence (AI) agents.

### BACKGROUND

In modern industrial and enterprise environments, operational planning and scheduling are critical to achieving efficiency, productivity, and responsiveness to changing supply chain dynamics. Enterprises often rely on a combination of traditional systems such as at least one of: Enterprise Resource Planning (ERP) systems, Manufacturing Execution Systems (MES), spreadsheets, and rule-based scheduling tools to perform functions such as production planning, material requirement planning (MRP), sales and operations planning (S&OP), and dispatch scheduling.

However, these traditional systems are inherently limited in their ability to adapt to dynamic, real-world complexities. Most existing planning tools operate on pre-configured rule sets or static optimisation functions that require manual programming, rule maintenance, and data cleansing. The traditional systems typically assume highly structured inputs and often lack interoperability across unstructured or unconstrained data sources such as electronic mail (emails), portable document format (PDF) attachments, scanned spreadsheets, or contextual planning narratives.

Moreover, the process of configuring such traditional systems often demands intensive manual efforts, domain expertise, and technical knowledge, making the traditional systems inflexible in responding to frequent operational changes or domain-specific variations in planning logic. As a result, planners and operations managers continue to rely on tribal knowledge, undocumented logic, and siloed spreadsheets, which severely limit scalability, repeatability, and transparency in decision-making.

In the existing technology, a system for production planning using machine learning to forecast demand and align production schedules is disclosed. The system utilises structured ERP data and machine learning models to generate optimised production plans. However, it does not support unstructured data processing from visual or audio sources, nor does it allow end users to teach the system using narrated workflows or screen recordings. Furthermore, the system lacks conversational interfaces for logic modification and does not provide multi-level “why-why” root-cause analysis to explain planning decisions.

There are various technical problems with the operational planning and scheduling in the prior art. In the existing technology, the traditional systems do not support multimodal inputs such as video or audio explanations. Planning logic is not user-teachable via screen-recorded workflows or domain-specific narration. This leads to cumbersome efforts when scaling the model across multiple industries or plants, such as Electronics Manufacturing Services (EMS), MedTech, automotive, and consumer goods. The traditional systems do not include one or more large language models (LLMs) or one or more visual language models (VLMs) integration for extracting business logic from unstructured or semi-structured inputs. The traditional systems lack natural language interaction for editing, querying, or explaining plans. Further, the prior art systems fail to support recursive root-cause analysis (why-why) for explainable planning.

Another key shortfall of the traditional systems is the lack of human-in-the-loop adaptability and explainability. The traditional systems do not support conversational interfaces or the ability to alter, question, or interpret the generated planning outcomes using natural language. The traditional systems also fail to provide recursive root-cause explanations or real-time optimisation feedback in response to plan changes or operational disruptions.

Therefore, there is a need for an intelligent and adaptive operational planning and scheduling system that overcomes the limitations of conventional rule-based and machine learning systems. There is also a need for a system that allows non-technical users to teach and modify planning logic using natural language interfaces in real-time, without requiring traditional programming or rule configuration. Furthermore, such a system should support continuous learning, dynamic optimisation, and root-cause analysis to provide transparent, explainable planning outcomes that adapt to operational changes and user feedback.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In order to overcome the above deficiencies of the prior art, the present disclosure is to solve the technical problem by providing an artificial intelligence-based (AI-based) system and method for generating optimised operation planning and scheduling output using one or more domain-specific generative artificial intelligence (AI) agents.

In accordance with an embodiment of the present disclosure, the AI-based method for generating optimised operation planning and scheduling output is disclosed. In the first step, the AI-based method includes creating, by one or more hardware processors through a workflow creating subsystem, one or more workflows configured to at least one of: generate and execute operation planning and scheduling procedures, and alter the generated operation planning and scheduling procedures, associated with each workflow of the one or more workflows. Each workflow of the one or more workflows comprises a plurality of modules. The plurality of modules comprises at least one of: an operation planning module, a material requirement planning module, a sales and operations planning module, and a dispatch planning module. The plurality of modules is configured with the one or more domain-specific generative AI agents. The operation planning module is configured to generate resource-aware production schedules to optimise an allocation of at least one of: manpower, machines, market demand, production calendar, and material usage over a defined time horizon. The material requirement planning module is configured to compute and schedule a procurement and availability of materials required for operations. The sales and operations planning module is configured to reconcile demand forecasts and sales objectives with production and material constraints to generate medium-to-long-term sales and operations planning (S&OP) outputs. The dispatch planning module is configured to generate dispatch plans based on finished goods availability, delivery schedules, customer service levels, and logistics constraints.

In the next step, the AI-based method includes obtaining, by the one or more hardware processors through a data obtaining subsystem, at least one of: one or more data explanation videos, one or more process understanding videos, and unconstrained operational planning data, from at least one of: one or more cloud storage services, one or more end devices associated with one or more users, and one or more data management sources. The one or more data explanation videos comprise at least one of: a recorded narration explaining at least one of: structure, purpose, and semantic meaning of one or more input and output files used in the operation planning and scheduling procedures, a walkthrough of column headers, data formats, and inter-sheet dependencies, and at least one of: a visual and a verbal description of uploaded data relates to production planning variables including inventory, manpower, and machine availability. The one or more process understanding videos comprise at least one of: a recorded screen interaction demonstrating the step-by-step execution of a planning workflow, a voice-narrated explanation of at least one of: business logics, constraints, and rules applied during manual planning, and a visual representation of decisions made during planning, comprising at least one of: sequencing, priority handling, and bottleneck resolution. The unconstrained operational planning data comprises at least one of: production data, planning and transactional data, and unstructured communication data.

In the next step, the AI-based method includes extracting, by the one or more hardware processors through a data extraction subsystem, at least one of: a) one or more informative image frames from at least one of: the one or more data explanation videos, and the one or more process understanding videos, through one or more computer vision models, and b) audio data associated with the one or more informative image frames, in a text format, from at least one of: the one or more data explanation videos, and the one or more process understanding videos, using one or more large language models (LLMs) associated with one or more AI models. Further, extracting, by the one or more computer vision models, the one or more informative image frames by determining momentous scene transitions based on a visual similarity threshold. Transcribing, by a speech-to-text engine associated with the one or more LLMs, the audio data to identify domain-specific vocabulary based on the context of the at least one of: the one or more data explanation videos, and the one or more process understanding videos.

In the next step, the AI-based method includes analysing, by the one or more hardware processors through a data analysis subsystem, the one or more informative image frames and the audio data, by using at least one of: one or more visual language models (VLMs) and the one or more LLMs associated with the one or more AI models, to generate a planning standard operating procedure (SOP). Further, the step comprises amending, by the one or more users through the data analysis subsystem, the generated planning SOP by using natural language instructions in at least one of: the generative AI environment, and the conversation AI environment, to update the operation planning and scheduling.

In the next step, the AI-based method includes pre-processing, by the one or more hardware processors through a data pre-processing subsystem, the unconstrained operational planning data to generate constrained operational planning data through at least one of: normalisation, feature engineering, and context-aware data transformation.

In the next step, the AI-based method includes receiving, by the one or more hardware processors through a prompts receiving subsystem, one or more prompts from a user of the one or more users associated with a user profile, in at least one of: the generative AI environment, and the conversation AI environment. The one or more prompts comprise at least one of: a) requesting one of: generation and regeneration of an operational plan based on at least one of: the SOP, the constrained operational planning data, b) an instruction to amend the planning SOP, including at least one of: production quantity, shift timing, resource allocation, and priority rules, c) a request to simulate alternate planning scenarios based on hypothetical changes in one of: demand, supply, and capacity, and d) a query for at least one of: insights, justifications, and root-cause explanations related to the generated optimised operation planning and scheduling output.

In the next step, the AI-based method includes processing, by the one or more hardware processors through a data processing subsystem, at least one of: the planning SOP, the constrained operational planning data, and the one or more prompts by utilizing one or more domain-specific generative AI agents, to generate an optimised function through at least one of: data mapping procedures, feature engineering procedures. The optimised function comprises at least one of: a multi-variable, constraint-aware optimisation model configured to generate the optimised operation planning and scheduling output based on inputs including at least one of: source availability data, demand forecasts data, inventory levels data, and personnel shifts data, in at least one of: the planning SOP, the constrained operational planning data.

The one or more domain-specific generative AI agents comprise a task decomposition engine. The task decomposition engine is configured to split at least one of: the planning SOP, the constrained operational planning data, and the one or more prompts, into multiple subtasks and distribute the multiple subtasks to each domain-specific generative AI agent of the one or more domain-specific generative AI agents for parallel execution. The one or more domain-specific generative AI agents are trained and retrained through a continuous training loop subsystem. The continuous training loop subsystem, comprising: a) capturing, by the one or more hardware processors, one or more user interactions with at least one of: the planning SOP, the one or more workflows, and the optimised operation planning and scheduling output, including natural language modifications and feedback, b) updating, by the one or more hardware processors, the one or more domain-specific generative AI agents based on at least one of: task outcomes, success rates, execution accuracy, and user alterations, c) storing, by the one or more hardware processors, in a learning repository, at least one of: amended planning SOPs, prompt-response pairs, and associated planning outcomes as training data, and d) retraining, by the one or more hardware processors, the one or more domain-specific generative AI agents by using the stored training data to generation the optimized operation planning and scheduling output over time.

In the next step, the AI-based method includes generating, by the one or more hardware processors through the data processing subsystem is configured with the one or more domain-specific generative AI agents, the optimised operation planning and scheduling output based on the optimised function with a continuous feedback loop configured to adapt the optimised function in response to at least one of: the one or more prompts, amended planning SOP, and real-time changes in the constrained operational planning data. The optimised operational planning and scheduling output includes generation of at least one of: a production schedule by time slot and resource allocation, material procurement planning, shift-wise workforce allocation planning, and dispatch planning and delivery scheduling.

In accordance with an embodiment of the present disclosure, the AI-based system for generating the optimised operation planning and scheduling output is disclosed. The AI-based system comprises one or more servers configured with the one or more hardware processors, and a memory unit. The memory unit is operatively connected to the one or more hardware processors. The memory unit comprises a set of computer-readable instructions in form of a plurality of subsystems, configured to be executed by the one or more hardware processors. The plurality of subsystems comprises the workflow creating subsystem, the data obtaining subsystem, the data extraction subsystem, the data analysis subsystem, the data pre-processing subsystem, the prompts receiving subsystem, and the data processing subsystem.

In an aspect, the workflow creating subsystem is configured to create the one or more workflows to at least one of: generate and execute the operation planning and scheduling procedures, and alter the generated operation planning and scheduling procedures, associated with each workflow of the one or more workflows.

In other aspect, the data obtaining subsystem is configured to obtain at least one of: the one or more data explanation videos, the one or more process understanding videos, and the unconstrained operational planning data, from at least one of: the one or more cloud storage services, the one or more end devices associated with the one or more users, and the one or more data management sources.

Yet other aspects, the data extraction subsystem is configured to extract at least one of: a) the one or more informative image frames from at least one of: the one or more data explanation videos, and the one or more process understanding videos, through the one or more computer vision models, b) the audio data associated with the one or more informative image frames, in the text format, from at least one of: the one or more data explanation videos, and the one or more process understanding videos, by using the one or more LLMs associated with one or more AI models.

In another aspect, the data analysis subsystem is configured to analyse the one or more informative image frames and the audio data, by using at least one of: the one or more VLMs and the one or more LLMs associated with the one or more AI models, for generating a planning SOP.

Yet another aspect, the data pre-processing subsystem is configured to pre-process the unconstrained operational planning data to generate the constrained operational planning data through at least one of: the normalisation, the feature engineering, and the context-aware data transformation.

In other aspects, the prompts receiving subsystem is configured to receive the one or more prompts from the user of the one or more users associated with the user profile, in at least one of: the generative AI environment, and the conversation AI environment.

Yet other aspects, the data processing subsystem configured to: a) process at least one of: the planning SOP, the constrained operational planning data, and the one or more prompts by utilizing one or more domain-specific generative AI agents, to generate the optimised function through at least one of: the data mapping procedures, and the feature engineering procedures, and b) generate the optimised operation planning and scheduling output based on the optimised function with the continuous feedback loop configured to adapt the optimised function in response to at least one of: the one or more prompts, the updated planning SOP, and the real-time changes in the constrained operational planning data.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail, with the accompanying figures in which:

FIG. 1 illustrates an exemplary block diagram representation of a network architecture depicting an artificial intelligence-based (AI-based) system for generating optimised operation planning and scheduling output, in accordance with an embodiment of the present disclosure;

FIG. 2 illustrates an exemplary block diagram representation of the AI-based system as shown in FIG. 1 for generating the optimised operation planning and scheduling output, in accordance with an embodiment of the present invention;

FIG. 3 illustrates an exemplary product workflow representation of the AI-based system for generating the optimised operation planning and scheduling output, in accordance with an embodiment of the present invention.

FIG. 4 illustrates an exemplary high level tech architecture of the AI-based system, in accordance with an embodiment of the present invention.

FIG. 5 illustrates an exemplary schematic diagram of agentic workflow for one or more prompts from the user, in accordance with an embodiment of the present invention.

FIG. 6 illustrates an exemplary a flowchart diagram for generating the optimised operation planning and scheduling output using generative AI-based agentic models, in accordance with an embodiment of the present invention.

FIG. 7 illustrates an exemplary dashboard interface of the AI-based system product workflow for generating the optimised operation planning and scheduling output, in accordance with an embodiment of the present invention;

FIG. 8 illustrates an exemplary flowchart of an AI-based method for generating the optimised operation planning and scheduling output, in accordance with an embodiment of the present invention.

Further, those skilled in the art will appreciate that elements in the figures are illustrated for simplicity and may not have necessarily been drawn to scale. Furthermore, in terms of the method steps, and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components preceded by “comprises . . . a” does not, without more constraints, preclude the existence of other components or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an artificial intelligence-based (AI-based) system and method for generating optimised operation planning and scheduling output using one or more domain-specific generative artificial intelligence (AI) agents.

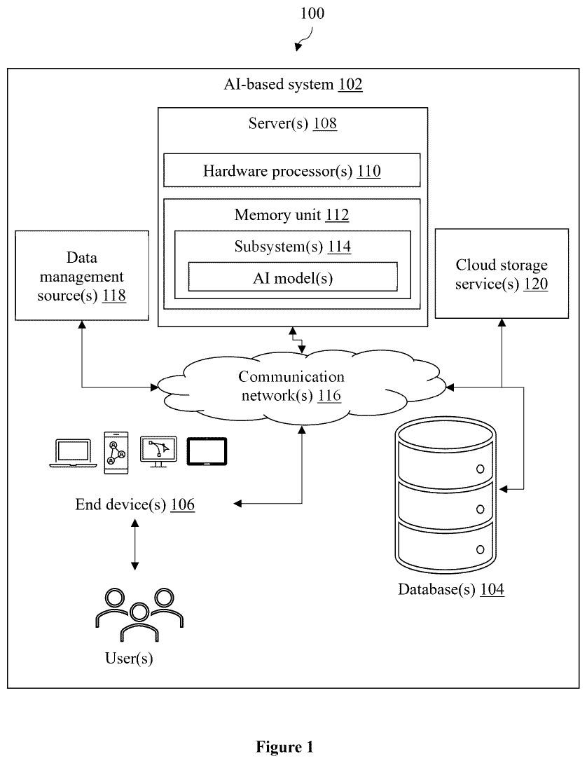

FIG. 1 illustrates an exemplary block diagram representation of a network architecture 100 depicting an artificial intelligence-based (AI-based) system 102 for generating optimised operation planning and scheduling output, in accordance with an embodiment of the present disclosure;

According to an exemplary embodiment of the present disclosure, the network architecture 100 includes a computing environment comprising the AI-based system 102 communicatively coupled to one or more users, one or more end devices 106, one or more databases 104, one or more data management sources 118, and one or more cloud storage services 120 via one or more communication networks 116. The AI-based system 102 acts as a central processing unit within the network architecture 100, responsible for generating optimised the operation planning and scheduling output.

In an exemplary embodiment, the AI-based system 102 comprises one or more servers 108, each configured with one or more hardware processors 110 and a memory unit 112. The one or more servers 108 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or the one or more hardware processors 110. The memory unit 112 stores executable program instructions and is further configured to include a plurality of subsystems 114, which collectively enable the generation of optimized operation planning and scheduling outputs, as described in further detail with respect to other figures.

In an exemplary embodiment, the one or more hardware processors 110 may include one or more microprocessors, logic circuits, or specialized processors capable of executing one or more AI models, running optimization functions, and coordinating interaction among the plurality of subsystems 114. The one or more hardware processors 110 are responsible for the execution of one or more AI models, one or more machine learning models, natural language processing, one or more visual language models (VLMs), one or more large language models (LLMs), and data transformation procedures. The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the AI-based system 102 for performing tasks such as performing comparative analysis, input/output processing, and/or any other functions. Any reference to a task in the present disclosure may refer to an operation or that may be performed to generate optimised the operation planning and scheduling output. The one or more hardware processors 110 are high-performance processors capable of handling large volumes data and complex computations. The one or more hardware processors 110 may be, but not limited to, at least one of: multi-core central processing units (CPU), a graphics processing unit (GPU)-based processing unit, a neural processing unit (NPU), and the like that enhance an ability of the AI-based system 102 to generate the optimised operation planning and scheduling output.

In an exemplary embodiment, the memory unit 112 may include volatile memory (e.g., random access memory (RAM)), non-volatile memory (e.g., read-only memory (ROM), flash), and/or storage memory. It retains machine-readable instructions and data structures required to operate the AI-based system 102, including planning models, user workflows, and intermediate outputs.

In an exemplary embodiment, the plurality of subsystems 114 are modular software or firmware components hosted within the memory unit 112 and executed by the one or more hardware processors 110. The plurality of subsystems may collectively enable workflow creation, data ingestion, model execution, optimization, and user interaction. Detailed operation of the plurality of subsystems 114 is described in subsequent figures.

In an exemplary embodiment, the one or more end devices 106 represent computing devices used by the one or more users to interact with the AI-based system 102. The one or more end devices 106 may include, but not limited to, one of: desktop computers, laptops, smartphones, tablets, phablets, industrial terminals, and the like. Through these one or more end devices 106, users may upload input files, one or more data explanation videos, one or more process understanding videos, one or more prompts, validate system outputs, and alter one or more workflows using one of: graphical interfaces and conversational interfaces. The one or more end devices 106 may also support multimodal inputs, allowing the one or more users to interact through voice commands, text inputs, or gesture-based controls, ensuring accessibility and ease of use across different user demographics. The one or more end devices 106 are configured to securely transmit and receive data to and from the AI-based system 102 via the one or more communication networks 116, ensuring seamless user experience and real-time synchronization.

In an exemplary embodiment, the one or more users represent individuals or entities such as supply chain planners, supply chain managers, or domain experts who interact with the AI-based system 102. User interactions may include initiating the one or more workflows, uploading the input files, the one or more data explanation videos, the one or more process understanding videos, entering the one or more prompts in natural language, and reviewing or editing generated planning outputs.

In an exemplary embodiment, the one or more communication networks 116 facilitates data transmission between the AI-based system 102 and external components, including the one or more end devices 106, the one or more databases 104, one or more data management sources 118, and the one or more cloud storage services 120. The one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fibre optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBcc®, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the one or more databases 104 are configured to store structured and semi-structured data related various aspects of the AI-based system 102. The one or more databases 104 may store at least one of, but not limited to, planning operations, such as historical production records, material inventories, SOP versions, AI model outputs, planning constraints, user feedback, and the like. The one or more databases 104 may be internally or externally hosted and are queried or updated by the plurality of subsystems 114 during the one or more workflows execution. The one or more databases 104 serve as a centralized repository for critical data elements that are integral to the secure operation of the AI-based system 102, enabling efficient management and synchronization of data associated with the AI-based system 102. The one or more databases 104 enable the AI-based system 102 to dynamically retrieve, analyse, and update the stored data and the lending criteria data in real-time, for generating the optimised operation planning and scheduling output. The one or more databases 104 may include different types of databases such as, but not limited to, may include different types of databases such as, but not limited to, relational databases (e.g., Structured Query Language (SQL) databases such as PostgresDB and Oracle® databases), non-Structured Query Language (NoSQL) databases (e.g., MongoDB, Cassandra), time-series databases (e.g., InfluxDB), an OpenSearch database, object storage systems (e.g., Amazon® S3), and the like.

In an exemplary embodiment, the one or more data management sources 118 include enterprise systems such as, but not limited to, at least one of: Manufacturing Execution Systems (MES), Enterprise Resource Planning (ERP) platforms, and third-party tools that generate or manage planning-related data. The one or more data management sources 118 typically provide structured inputs such as, but not limited to, at least one of: bill of materials (BOM), work orders, sales forecasts, market demand, production calendar, and machine availability logs, which are accessed by the AI-based system 102 through one of: one or more Application Programming Interfaces (APIs) and one or more data connectors.

In an exemplary embodiment, the one or more cloud storage services 120 may include public, private, or hybrid cloud platforms where the one or more users or one or more systems store supporting documents, screen recordings, spreadsheets, or other unstructured input data. The AI-based system 102 retrieves such data for processing as part of the planning and scheduling the one or more workflow.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more end devices 106 connected to the one or more databases 104, one skilled in the art may envision that the AI-based system 102, and the one or more end devices 106 may be connected to several user devices located at various locations and several databases via the one or more communication networks 116.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

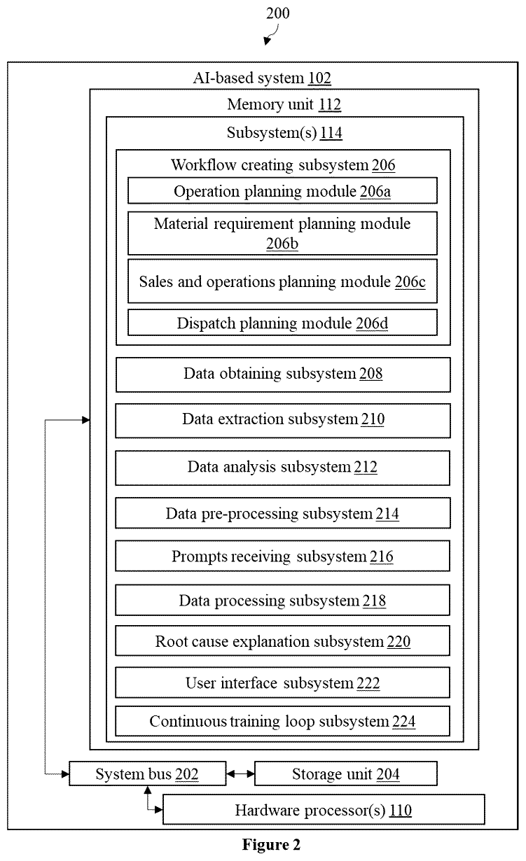

FIG. 2 illustrates an exemplary block diagram representation 200 of the AI-based system 102 as shown in FIG. 1 for generating the optimised operation planning and scheduling output, in accordance with an embodiment of the present invention.

In an exemplary embodiment, the AI-based system 102 (hereinafter referred to as the system 102) comprises the one or more servers 108, the memory unit 112, and a storage unit 204. The one or more hardware processors 110, the memory unit 112, and the storage unit 204 are communicatively coupled through a system bus 202 or any similar mechanism. The system bus 202 functions as the central conduit for data transfer and communication between the one or more hardware processors 110, the memory unit 112, and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 112 is operatively connected to the one or more hardware processors 110. The memory unit 112 comprises the plurality of subsystems 114 in the form of programmable instructions executable by the one or more hardware processors 110. The plurality of subsystems 114 comprises a workflow creating subsystem 206, a data obtaining subsystem 208, a data extraction subsystem 210, a data analysis subsystem 212, a data pre-processing subsystem 214, a prompts receiving subsystem 216, a data processing subsystem 218, a root cause explanation subsystem 220, a user interface subsystem 222, and a continuous training loop subsystem 224. The one or more hardware processors 110, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as the ROM, the RAM, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 may store, but not limited to, recommended course of action sequences dynamically generated by the system 102. The action sequences comprise a) execution steps derived from the planning standard operating procedure (SOP), b) dynamically generated sub-tasks created by the one or more domain-specific AI models using a task decomposition engine, c) corrective actions recommended by the root cause explanation subsystem 220 in response to identified deviations or planning exceptions, d) updates to the planning workflow triggered by the one or more prompts received through the prompts receiving subsystem 216, and e) versioned modifications to planning constraints or SOP logic based on real-time feedback processed by the continuous feedback loop.

The storage unit 204 is structured to enable efficient retrieval and management of large datasets and dynamic action sequences. The storage unit 204 supports real-time synchronization with the plurality of subsystems 114 and ensures that the recommendations and action sequences remain accurate and up-to-date. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

Furthermore, the storage unit 204 remains a central repository for managing data essential to the AI-based system 102, enabling dynamic, real-time updates, seamless data flow, and actionable insights for generating the optimised operation planning and scheduling output. This interconnected architecture supports the system's adaptability, scalability, and ability to deliver personalized and accurate recommendations to the user.

In an exemplary embodiment, the workflow creating subsystem 206 is configured to create the one or more workflows to at least one of: generate and execute the operation planning and scheduling procedures, and alter the generated operation planning and scheduling procedures, associated with each workflow of the one or more workflows. Each workflow of the one or more workflows comprises a plurality of modules, wherein each module is configured to perform a specific domain function related to enterprise planning and is executable in response to user interaction or automated system triggers. The plurality of modules comprises, but not limited to, at least one of: an operation planning module 206a, a material requirement planning module 206b, a sales and operations planning module 206c, a dispatch planning module 206d, and the like. The plurality of modules is configured with the one or more domain-specific generative AI agents, which may include one or more large language models (LLMs), one or more visual language models (VLMs), and task-decomposing AI agents trained on historical planning workflows, standard operating procedures (SOPs), and execution data.

In an exemplary embodiment, the operation planning module 206a is configured to generate resource-aware production schedules to optimise an allocation of at least one of: manpower, machines, and material usage over a defined time horizon. The operation planning module 206a may include parsing the planning SOP to identify job orders, machine capabilities, available shift hours, and resource constraints to generate at least one of: the production plan and the dispatch plan. The operation planning module 206a is configured to allocate tasks based on real-time availability data and planning constraints derived from the constrained operational planning data pre-processed by the data pre-processing subsystem 214. The production schedules may be expressed in tabular, graphical, or Gantt-chart formats, and are adaptable based on user-provided the one or more prompts via the prompts receiving subsystem 216.

In an exemplary embodiment, the material requirement planning module 206b is configured to compute and schedule a procurement and availability of materials required for operations. The material requirement planning module 206b is configured to receive demand and job order information from the operation planning module 206a and extracts the BoM and the inventory levels from the one or more data management sources 118 such as, but not limited to at least one of: the MES, the ERP, Oracle®, and systems, applications, and products (SAP®), electronic mails and mail servers, and the like. The material requirement planning module 206b is configured to perform a net requirements calculation by offsetting current stock against expected demand and lead times. The material requirement planning module 206b is then recommends procurement dates, reorder points, and quantities, which may be reviewed and altered based on the user prompts or real-time data updates received via the continuous feedback loop.

In an exemplary embodiment, the sales and operations planning module 206c is configured to reconcile demand forecasts and sales objectives with production and material constraints to generate medium-to-long-term sales and operations planning (S&OP) outputs. The sales and operations planning module 206c includes integrating data from historical sales, forecast models, supply chain capacity, and operations strategy to produce demand-supply balancing plans. The sales and operations planning module 206c is configured to leverage the one or more AI models to simulate multiple planning scenarios and resolve conflicts between top-down (sales-driven) and bottom-up (capacity-driven) plans. The generated S&OP outputs may be aligned with financial targets and strategic objectives and reviewed using the user interface subsystem 222.

In an exemplary embodiment, the dispatch planning module 206d is configured to generate dispatch plans based on finished goods availability, delivery schedules, customer service levels, and logistics constraints. The dispatch planning module 206d is configured to evaluate production completion timelines (from the operation planning module 206a), inventory availability (from the material requirement planning module 206b), and customer delivery requirements to generate outbound shipment schedules. The dispatch planning module 206d is configured to consider logistics factors such as shipping windows, carrier capacity, priority orders, and service-level agreements (SLAs). The dispatch planning module 206d also enables automatic adjustments when upstream schedules change or when external disruptions (e.g., transport delays) occur, using the root cause explanation subsystem 220 to trace affected deliveries and recommend corrective actions.

In an exemplary embodiment, the data obtaining subsystem 208 is configured to obtain at least one of: the one or more data explanation videos, the one or more process understanding videos, and the unconstrained operational planning data, from at least one of: the one or more cloud storage services 120, the one or more end devices 106 associated with the one or more users, and the one or more data management sources 118. The data obtaining subsystem 208 may operate via the secure API integrations, direct file upload interfaces, or storage service connectors to retrieve content in various formats, including, but not limited to, MPEG-4 Part 14 (MP4), audio video interleave (AVI), Microsoft® Excel Spreadsheet (XLSX), comma separated values (CSV), Portable Document Format (PDF), Microsoft® Word Open XML Docume(DOCX), email (.eml), and image-based formats such as Portable Network Graphics (PNG) or joint photographic experts group (JPEG). The data obtaining subsystem 208 is capable of ingesting both real-time and batch data, and is designed to support asynchronous uploads and retrievals, enabling users to work offline and submit data later for processing. In another exemplary embodiment, the user is able to record the one or more data explanation videos and the one or more process understanding videos directly from the one or more end devices 106 associated with the one or more users.

The one or more data explanation videos comprise at least one of: a recorded narration explaining at least one of: structure, purpose, and semantic meaning of one or more input and output files used in the operation planning and scheduling procedures. Such narrations may include verbal descriptions of each data field, its role in the planning logic, and examples of how values influence downstream outputs. For instance, a user may explain that a column labelled “machine_availability” in an input Excel file represents the number of available hours for a machine per shift and how it impacts task allocation. The one or more data explanation videos may further include a walkthrough of column headers, data formats, and inter-sheet dependencies, where a user visually scrolls through the spreadsheet, pointing out how values are derived across sheets, such as material requirements flowing from a BoM tab to a scheduling tab. Additionally, the one or more data explanation videos may contain at least one of: a visual and a verbal description of uploaded data that relates to production planning variables, including but not limited to inventory levels, manpower availability, and machine operational status. The multimodal explanations in the one or more data explanation videos provide essential context for downstream subsystems, particularly for aligning user-specific logic with the planning SOPs.

The one or more process understanding videos comprise at least one of: a recorded screen interaction demonstrating the step-by-step execution of a planning workflow by a domain expert. The one or more process understanding videos may involve recording a user manipulating spreadsheet logic, filtering rows, applying conditional formatting, or entering formulas used in manual planning. Additionally, the one or more process understanding videos may include a voice-narrated explanation of at least one of: business logics, constraints, and rules applied during manual planning. For example, the narration may explain that “urgent orders must be allocated to night shifts due to limited daytime capacity,” or that “maintenance tasks override normal production if flagged by the maintenance scheduler.” Furthermore, the one or more process understanding videos may include a visual representation of decisions made during planning, comprising at least one of: sequencing of tasks, priority handling of jobs, and bottleneck resolution strategies (e.g., machine reassignment, operator substitution, task rescheduling). The components in the one or more process understanding videos provide critical insight into planning heuristics and domain-specific constraints, which are later parsed and transformed into machine-readable planning SOPs by the data analysis subsystem 212.

The unconstrained operational planning data comprises, but not limited to, at least one of: production data, planning and transactional data, unstructured communication data, and the like. The production data may include, but not limited to, at least one of: machine runtime logs, work-in-progress (WIP) records, shift attendance, quality inspection results, and the like. The production data is often exported from data management sources 118, such as the MES or IoT platforms, in semi-structured formats (CSV/XML/JSON). The planning and transactional data may include, but not limited to, at least one of: demand forecasts, sales orders, bills of materials, shift rosters, inventory snapshots, and the like, typically sourced from ERP or SCM systems and representing real-time or historical views of business commitments. The unstructured communication data may include, but not limited to, at least one of: email messages, scanned documents, meeting notes, and embedded spreadsheet attachments communicated between departments or suppliers. Such data may contain informal planning inputs, delivery updates, last-minute constraint changes, or undocumented rule exceptions that are not reflected in structured ERP data. These inputs, although loosely formatted, are critically relevant for the planning logic and must be interpreted and integrated into the workflow creation process via subsequent subsystems.

In an exemplary embodiment, the data extraction subsystem 210 is configured to extract the one or more informative image frames from at least one of: the one or more data explanation videos, and the one or more process understanding videos, through the one or more computer vision models. The data extraction subsystem 210 is configured to process at least one of: the one or more data explanation videos, and the one or more process understanding videos, frame-by-frame and applies scene segmentation models to identify and isolate the one or more informative image frames. The one or more informative image frames represent meaningful transitions in at least one of: the one or more data explanation videos, and the one or more process understanding videos, such as when a user changes the screen, scrolls to a different data table, switches to another application window, or opens a new worksheet within a spreadsheet file.

The extraction of the one or more informative image frames is performed by determining momentous scene transitions based on a visual similarity threshold. Specifically, the visual similarity threshold is a numeric or algorithmic condition that quantifies the dissimilarity between two consecutive or temporally spaced frames. When the change in one or more informative image frames content exceeds this threshold, measured using pixel-level comparison techniques such as, but not limited to, one of: a structural similarity index (SSIM), histogram differences, feature embedding distance, and the like, a scene transition is detected, and the corresponding frame is marked as informative. The data extraction subsystem 210 is configured to enable the system 102 to discard repetitive or visually similar frames and retain only those that reflect a meaningful change in the user's on-screen actions, ensuring optimal use of processing resources and focusing the downstream analysis on decision-relevant content.

In parallel, the data extraction subsystem 210 is configured to extract the audio data associated with the one or more informative image frames, in the text format, from at least one of: the one or more data explanation videos, and the one or more process understanding videos, by using the one or more LLMs associated with one or more AI models. In this embodiment, an audio track from at least one of: the one or more data explanation videos, and the one or more process understanding videos is separated into timestamp-aligned segments that correspond to the detected one or more informative image frames. Each audio segment is then fed into a speech-to-text engine, which may include models such as, but not limited to, one of: a fine-tuned Whisper model, a DeepSpeech model, and similar AI-based transcription frameworks.

Transcribing, by the speech-to-text engine associated with the one or more LLMs, the audio data includes converting raw speech into structured text while also identifying domain-specific vocabulary based on the context of at least one of: the one or more data explanation videos, and the one or more process understanding videos. This contextual recognition is enabled through the one or more LLMs prompting and fine-tuning, where the transcription engine references an internal knowledge base or vocabulary model trained on manufacturing, planning, and scheduling terminology. For example, if the user verbally refers to terms like “reorder point,” “OEE,” “shift lead time,” or “changeover loss,” the system 102 is able to detect these as high-value keywords and preserve them accurately in the output text.

In some embodiments, additional pre-processing may be performed to align the extracted text with the corresponding informative image frames, using temporal synchronization and metadata tagging. This allows the downstream data analysis subsystem 212 to receive a composite input consisting of (i) static visual representations of key workflow stages, and (ii) semantically enriched natural language transcripts that reflect the user's verbal reasoning at each stage. The combination of structured visual data and contextual textual data significantly improves the ability of the system 102 to learn planning logic, extract constraints, and generate accurate planning SOPs.

In an exemplary embodiment, the data analysis subsystem 212 is configured to analyse the one or more informative image frames and the audio data, by using at least one of: the one or more VLMs and the one or more LLMs associated with the one or more AI models, for generating a planning SOP. The data analysis subsystem 212 serves as the core engine for semantic understanding and logic extraction from multimodal planning data obtained and pre-processed in upstream subsystems. The analysis of the one or more informative image frames is performed by the one or more VLMs, which receive visual input in the form of still images extracted from at least one of: the one or more data explanation videos, and the one or more process understanding videos. The one or more informative image frames typically represent screenshots of spreadsheets, software interfaces, dashboards, or workflow steps visually demonstrated by the user. The VLMs apply spatial-textual alignment models (e.g., transformer-based attention layers) to extract relevant features such as column headers, tabular layouts, user interface (UI) elements, or action indicators (e.g., cursor position, selection highlights). Each frame is encoded into a high-dimensional semantic vector that retains both visual structure and contextual information.

Simultaneously, the transcribed audio data converted into the text format by the data extraction subsystem 210 is processed by the one or more LLMs, which perform natural language understanding and domain-specific entity recognition. The LLMs are fine-tuned to interpret planning-related terminology such as “reorder point,” “resource constraint,” “lead time buffer,” or “shift-based allocation.” The one or more LLMs parse spoken narration into structured intermediate representations such as planning rules, priority conditions, constraints, or dependencies between data fields.

The data analysis subsystem 212 then fuses the visual understanding from the one or more VLMs and the linguistic understanding from the one or more LLMs to generate a coherent, machine-readable planning SOP. The planning SOP is typically represented in the form of a rule-based script, JSON object, or declarative workflow schema that maps user-explained logic into executable planning procedures. The planning SOP includes, but is not limited to, condition-action rules, resource-allocation logic, scheduling preferences, exception handling, and calculation dependencies extracted from user demonstrations.

In an advanced exemplary embodiment, the data analysis subsystem 212 is further configured to amend the generated planning SOP by using natural language instructions in at least one of: a generative AI environment, and a conversation AI environment, to update the operation planning and scheduling. This means that once the planning SOP has been initially created, the user may interact with the system 102 via a chat interface or natural language prompt interface to revise, extend, or correct the logic embedded in the planning SOP. For example, the user may input: “Please add a rule that orders with urgent priority must bypass the batching constraint,” or “Remove the overtime shift rule for weekends.” The data analysis subsystem 212 is configured to interpret the natural language instructions using the LLM, identifies the relevant sections of the planning SOP to be amended, and generates a revised version of the planning SOP that reflects the user's intent. The amendments are validated against previously extracted constraints and planning schemas to ensure consistency and logical completeness. The updated planning SOP is version-controlled and stored in the one or more database 104 or the storage unit 204 and is ready to be used by the workflow creating subsystem 206 for execution or further optimization by downstream components.

In an exemplary embodiment, the data pre-processing subsystem 214 is configured to pre-process the unconstrained operational planning data to generate the constrained operational planning data through at least one of: the normalisation, the feature engineering, and the context-aware data transformation. The unconstrained operational planning data, as previously obtained through the data obtaining subsystem 208, may include heterogeneous and loosely structured input formats such as Excel spreadsheets, CSV files, scanned documents, and email attachments. The files may vary significantly across users or enterprises in terms of column naming conventions, row hierarchies, sheet structures, data units, encoding standards, or even missing values. As such, this raw form is not directly usable for downstream AI-driven optimization tasks and must undergo structured preparation.

The data pre-processing subsystem 214 applies a pipeline of transformations to convert the unconstrained operational planning data into the constrained operational planning data, a normalized and semantically structured dataset that aligns with the schema expectations of the one or more domain-specific AI models. The process of normalisation includes operations that standardize input formats, eliminate noise, and harmonize value representations. For example: Date fields may be converted from various formats (e.g., “DD-MM-YYYY”, “MM/DD/YY”, textual month names) into a consistent ISO format. Numeric entries with units (e.g., “2 hrs”, “120 mins”) may be converted into a uniform time unit. Column headers such as “avail_mach”, “Machine Avail.”, and “M/C Avail” are mapped to a standard label such as “machine_availability” using predefined mapping dictionaries or AI-based semantic matching. Duplicated rows, merged cells, and formatting inconsistencies (common in Excel uploads) are resolved through rule-based or model-assisted cleaning routines.

The feature engineering process involves creating derived data fields that better represent planning constraints, decision variables, or performance metrics. These features are typically required by the data processing subsystem 218 and the optimization models to perform accurate and constraint-compliant scheduling. For instance: Deriving “machine utilization percentage” from available machine hours vs. scheduled tasks; Calculating “lead time buffer” as the difference between delivery due date and estimated production completion date; Computing “manpower shift load” based on planned tasks per employee and shift length; and extracting categorical encodings for priority classes (e.g., urgent, standard, low) from free-text fields or status indicators. The feature engineering may be performed using a combination of rule-based transformation scripts and learned functions trained on historical planning data or prior user workflows. These features enhance the representational capacity of the input data and improve the optimization model's ability to learn constraints and preferences. In addition to structured feature engineering, the system also supports prompt engineering for the one or more LLMs. This involves designing, adapting, and optimizing natural language prompt templates to improve the accuracy, consistency, and contextual relevance of the one or more LLMs generated outputs, such as the planning SOP generation, explanation tracing, and the one or more prompts. Prompt engineering strategics include use of few-shot examples, prompt chaining, system-role conditioning, and dynamic template generation based on user role, domain, and workflow state. The engineered prompts serve as soft constraints that guide the one or more LLMs behaviour to align with enterprise-specific planning logic.

The context-aware data transformation component dynamically interprets the operational context under which the unconstrained operational planning data is produced or is to be used, ensuring accurate alignment with user intent and domain logic. This transformation leverages insights extracted by the data analysis subsystem 212, such as the business rules inferred from narrated SOPs or embedded one or more prompts. For instance: If the planned SOP indicates that “overtime shifts must only be used when total demand exceeds 90% of nominal capacity,” the transformation logic may introduce a derived binary feature called “use_overtime_flag” which is activated conditionally. In multi-plant scenarios, item codes may be disambiguated using site-specific lookup tables or historical usage context (e.g., “A123” in Plant A may refer to a different part than in Plant B). Fields missing in the input file but inferred from audio descriptions in data explanation videos (e.g., “batch_size” not present but mentioned verbally) may be synthesized and injected into the dataset using semantic inference techniques powered by the one or more LLMs. Once all three pre-processing stages i.e., the normalisation, the feature engineering, and the context-aware data transformation are complete, the resulting constrained operational planning data is stored in memory and made available to the data processing subsystem 218.

In an exemplary embodiment, the prompts receiving subsystem 216 is configured to receive the one or more prompts from the user of the one or more users associated with the user profile, in at least one of: the generative AI environment, and the conversation AI environment. The prompts receiving subsystem 216 serves as the primary interface layer between the human decision-maker and the system 102, enabling interactive communication in natural language to configure, adjust, simulate, or inquire about planning workflows and outcomes. In this context, the generative AI environment may refer to an interface where the user interacts with the system 102 through freeform of the one or more prompts typically rendered as a text box, chat interface, or embedded AI assistant, where natural language input is parsed using the one or more LLMs. The conversation AI environment may include multi-turn dialog systems that maintain context over a sequence of user interactions, such as a chatbot-based assistant embedded within a web interface, enterprise portal, or mobile application.

The one or more prompts comprise, but not limited to, at least one of: “Generate a production plan based on the current SOP and inventory levels.” Or regenerate the schedule considering the updated constrained data for shift 2.” Upon receiving such a prompt within the one or more prompts, the prompts receiving subsystem 216 packages the request into a structured query and forwards the prompt to the data processing subsystem 218, which invokes the one or more domain-specific AI models to generate or regenerate an optimised operation planning and scheduling output. The one or more prompts may be executed on demand or scheduled as part of a batch process.

For instance: the one or more prompts may be an instruction to amend the planning SOP, including at least one of: production quantity, shift timing, resource allocation, and priority rules. The user may provide modification instructions to fine-tune the SOP, for example: “Increase the production quantity for Item A by 15% for week 2.”, “Change the shift timing for Line 4 to start at 6 AM.”, “Reallocate Task B to Machine M2 instead of M1.” Or “Set all priority 1 jobs to override maintenance constraints.”. The instructions are parsed by the one or more LLMs behind the prompts receiving subsystem 216, which uses semantic parsing, dependency extraction, and rule identification techniques to map natural language expressions to actionable changes in the planning SOP structure. The updated planning SOP is then passed to the data analysis subsystem 212 or the workflow creating subsystem 206 for regeneration and validation.

For instance: the one or more prompts may be a request to simulate alternate planning scenarios based on hypothetical changes in one of: demand, supply, and capacity. The user may issue simulation prompts such as: “What if demand increases by 20% in week 3?”, “Simulate the plan if Supplier X is delayed by 3 days.”, and “Show the impact on the schedule if we lose one shift per day next month.”. In this case, the prompts receiving subsystem 216 dynamically modifies the planning input context and forwards it to the data processing subsystem 218, which invokes planning functions configured to support multi-scenario simulation. Results are presented back to the user via the user interface subsystem 222, often with side-by-side comparison of baseline and simulated plans.

For instance: the one or more prompts may be a query for at least one of: insights, justifications, and root-cause explanations related to the generated optimised operation planning and scheduling output. The user may seek clarity or explanations for specific AI-generated outputs, using the one or more prompts like: “Why is Task C scheduled on Machine M3 instead of M1?”, Which constraint is causing delay in Order 1045?”, “Explain the root cause of the resource overload warning.”. In such cases, the prompts receiving subsystem 216 forwards the query to the root cause explanation subsystem 220, which performs a recursive why-why analysis or traces planning decisions back to original constraints, logic, or resource data. The output is then converted into a human-readable explanation and returned to the user through the same conversational environment. Each of the one or more prompts may be contextually linked to the user profile, allowing the system 102 to personalize responses or enforce access controls. For example, a planner may only have permission to edit shift timing, whereas a supply chain manager may have authority to simulate vendor disruptions. The prompts receiving subsystem 216 may maintain a session state and prompt history, allowing multi-step interactions, undo operations, or chaining of queries across a conversation.

In an exemplary embodiment, the data processing subsystem 218 is configured to process at least one of: the planning SOP, the constrained operational planning data, and the one or more prompts by utilizing one or more domain-specific generative AI agents, to generate the optimised function through at least one of: the data mapping procedures, and the feature engineering procedures. The data processing subsystem 218 serves as the computational core responsible for converting structured operational data and user-defined planning logic into mathematically optimized decisions. The data processing subsystem 218 ingests structured input objects, specifically, the planning SOP generated by the data analysis subsystem 212, the constrained operational planning data produced by the data pre-processing subsystem, and natural language prompts received via the prompts receiving subsystem 216.

During processing, the data processing subsystem 218 invokes data mapping procedures to align disparate data sources such as columnar formats in spreadsheets, SOP rule statements, and user preferences into a unified internal representation. For example, a mapping rule might define that “Order Type A” should be scheduled on “Machine M1” during “Shift 2” based on capacity and resource constraints specified in the SOP. The mapped data serves as the input for downstream feature engineering procedures, which derive calculated fields such as shift load, machine utilization, safety stock thresholds, or delivery buffers. These features serve as inputs to the optimization model.

The optimised function comprises at least one of: a multi-variable, constraint-aware optimisation model configured to generate the optimised operation planning and scheduling output. The multi-variable, constraint-aware optimisation model is parameterized to support decision variables such as task start time, machine assignment, order sequence, and operator allocation, while respecting constraints such as shift hours, machine availability, material lead times, and delivery deadlines. The multi-variable, constraint-aware optimisation model consumes as input at least one of: source availability data (e.g., machine calendars, preventive maintenance windows), demand forecasts data (e.g., sales order pipelines, forecast models), inventory levels data (e.g., on-hand stock, incoming shipments, reorder points), and personnel shifts data (e.g., worker skill sets, shift rosters, labour policies), from at least one of: the planning SOP and the constrained operational planning data.

The one or more domain-specific generative AI agents used within the data processing subsystem 218 comprise a task decomposition engine. The task decomposition engine is configured to split at least one of: the planning SOP, the constrained operational planning data, and the one or more prompts, into multiple subtasks and distribute the multiple subtasks to each domain-specific generative AI agent of the one or more domain-specific generative AI agents for parallel execution. For example, if the planning SOP contains rules for machine allocation, shift sequencing, and inventory buffering, the task decomposition engine may separate these into submodules such as: “Subtask A: Machine assignment planning”, “Subtask B: Shift balancing”, and “Subtask C: Inventory and material replenishment”. Each of these subtasks is routed to each domain-specific generative AI agent within the one or more domain-specific generative AI agents that has been trained on domain-specific data (e.g., manufacturing rules, logistics constraints, workforce regulations). The one or more domain-specific generative AI agents operate concurrently and share intermediate outputs via a common context store, thereby enabling scalable and efficient execution of large, complex planning scenarios.

The one or more domain-specific generative AI agents are trained and retrained through the continuous training loop subsystem 224, which ensures continual learning and adaptation to real-world changes. The continuous training loop subsystem 224 operates by executing a multi-stage learning cycle involving four key phases. The continuous training loop subsystem 224 is configured to capture the one or more user interactions with at least one of: the planning SOP, the one or more workflows, and the optimised operation planning and scheduling output, including natural language modifications and user feedback. These interactions may comprise SOP edits, manual overrides, scheduling corrections, or scenario simulations provided during planning sessions. The continuous training loop subsystem 224 is configured to execute the one or more domain-specific generative AI agents based on at least one of: task outcomes (such as delayed dispatches or missed constraints), success rates (including adherence to execution plans), execution accuracy (e.g., comparison between planned and actual outputs), and user alterations (such as changes introduced via prompts or conversational commands). The continuous training loop subsystem 224 is configured with the training loop performs to store in a learning repository, at least one of: amended planning SOPs, prompt-response pairs, and their associated planning outcomes as structured training data. The learning repository may be organized with version control and indexed by parameters such as domain, date, workflow type, or user role, ensuring transparency and traceability. Finally, the continuous training loop subsystem 224 is configured to perform a retraining the one or more domain-specific generative AI agents using the accumulated training data to enhance future generations of the optimised operation planning and scheduling output. The retraining process may employ techniques such as supervised fine-tuning on labelled interactions, reinforcement learning from user-provided reward signals, or transfer learning to generalize across the one or more workflows and enterprise contexts.

The data processing subsystem 218 is configured to generate the optimised operation planning and scheduling output based on the optimised function. The data processing subsystem 218 is configured with the continuous feedback loop configured to adapt the optimised function in response to at least one of: the one or more prompts, the updated planning SOP, and the real-time changes in the constrained operational planning data. The continuous feedback loop ensures that the planning logic remains flexible and reactive to dynamic business environments. For example: “A new user prompt may instruct the system 102 to exclude overtime shifts from the current schedule.”, “A modified SOP may redefine sequencing priorities based on updated product categories.”, or “A real-time inventory change (e.g., stockout of a critical raw material) may trigger reallocation of work orders.”. In such cases, the continuous feedback loop immediately adjusts internal weights, feature values, or constraint logic, of the one or more domain-specific generative AI agents and re-executes the affected portions of the optimization model to generate an updated output. The final optimised operation planning and scheduling output includes generation of at least one of: a production schedule by time slot and resource allocation (e.g., task-machine-time matrix), material procurement planning (e.g., vendor orders, delivery dates, reorder triggers), shift-wise workforce allocation planning (e.g., labour distribution per shift, skill matching), and dispatch planning and delivery scheduling (e.g., shipment sequence, transport windows, SLA compliance). These outputs are visualized and managed via the user interface subsystem 222 and stored in the one or more databases 104 for audit, execution, and reuse in future workflows.

In an exemplary embodiment, the root cause explanation subsystem 220 is configured to generate a multi-level causal trace for each identified task in the optimised operation planning and scheduling output through one or more problem-solving procedures (i.e., “why-why” analysis). The why-why analysis is a structured reasoning method used to identify the underlying chain of causes that lead to a specific anomaly, inefficiency, or deviation in the optimised operation planning and scheduling output. Technically, the why-why analysis begins with an observed issue or unexpected outcome such as a missed delivery date, an underutilized resource, or a planning bottleneck, and iteratively poses the question “why” at each decision point that contributed to the outcome. The root cause explanation subsystem 220 uses a multi-level causal graph or trace tree, constructed during the execution of the data processing subsystem 218, where each node represents an input variable, constraint, SOP logic rule, or model decision. At each level, the root cause explanation subsystem 220 identifies one or more upstream contributors based on dependency weights, constraint violations, or AI-generated decision scores.

The root cause explanation subsystem 220 is configured to operate by analysing the sequence of computational decisions and data dependencies that led to a particular output in the final plan, such as a machine-task assignment, a delivery delay, or a stockout-triggered schedule shift. For each such task, the root cause explanation subsystem 220 recursively traverses backward through the constraint satisfaction tree, one or more domain-specific generative AI agents input features, and the planning SOP logic to identify direct and indirect influencing factors. The sequence of computational decisions and data dependencies include, but not limited to, violated constraints (e.g., insufficient resource availability), high-priority rule enforcement (e.g., urgent orders overriding regular sequences), and historical performance data (e.g., resource unavailability trends). The multi-level causal trace comprises layered justifications at different abstraction levels, such as business rule level (“Order 1032 delayed due to low safety stock”), resource level (“Stock shortage caused by missed procurement window”), and operational decision level (“Procurement rescheduled due to vendor capacity constraint”). This structured trace allows the one or more users to not only observe what happened, but why it happened, and how upstream decisions propagated to downstream effects.

In an exemplary embodiment, the user interface subsystem 222 is configured to present at least one of: the optimised operation planning and scheduling output and a natural language explanation of the multi-level causal trace and one or more recommended corrective actions with one or more colour coding. The optimised operation planning and scheduling output may be rendered as at least one of: an interactive Gantt chart, timeline, calendar view, tabular report, and dashboard, where each task entry or decision point is annotated with a visual indicator. For instance, the colour coding may be applied to distinguish between on-track tasks (e.g., green), attention-required items like machine maintenance (e.g., amber), and critical bottlenecks or violations (e.g., red). When the user hovers over or selects a task, a dynamically generated natural language explanation is displayed, which interprets the reasoning behind the scheduling choice and suggests one or more corrective actions, such as alternate shift allocations, rescheduling options, or inventory prioritization techniques. These explanations are generated in real time using the one or more LLMs that are fine-tuned to interpret the structured causal trace and translate it into user-friendly narrative text. The system 102 may also enable comparison of alternate decision paths by overlaying “what-if” causal chains, allowing users to simulate how modifications to the planning SOP, resource availability, or constraints would have changed the outcome. The combined use of traceability, visual diagnostics, and natural language feedback ensures that the AI-driven planning system remains transparent, explainable, and actionable, supporting both operational oversight and continuous improvement.

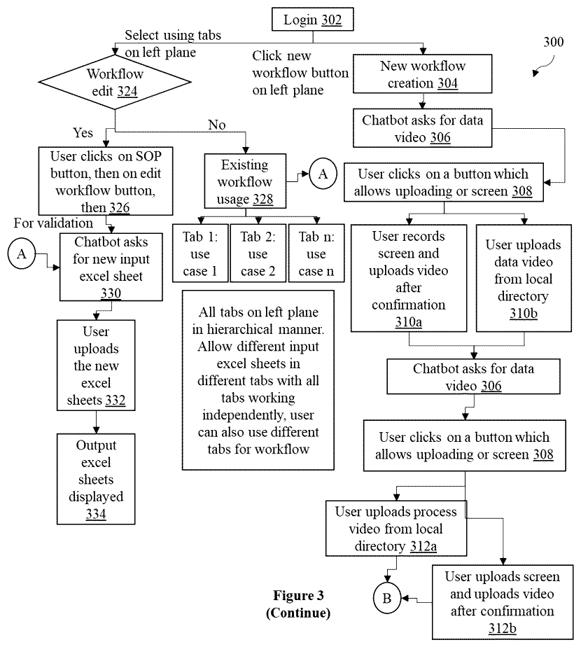

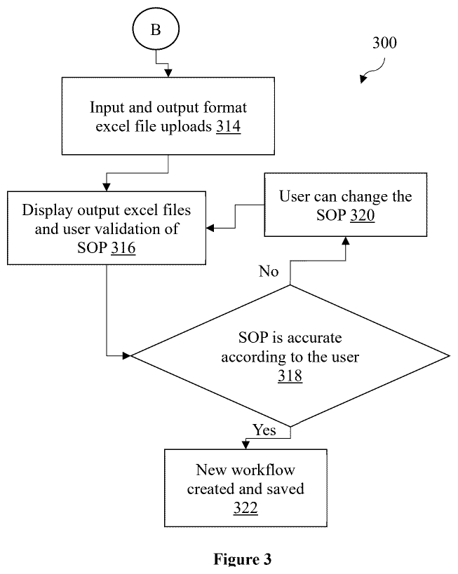

FIG. 3 illustrates an exemplary product workflow representation 300 of the AI-based system 102 for generating the optimised operation planning and scheduling output, in accordance with an embodiment of the present invention.

At step 302, the product workflow representation 300 begins with a user logging into the system 102 through a user interface. This step activates the necessary authentication mechanisms and loads the personalized workspace or dashboard, enabling access to existing workflows or the creation of new ones. At step 304, the user initiates a new workflow process. This invokes the workflow creating subsystem 206, allowing the user to generate the workflow process for generating the optimised operation planning and scheduling output. At step 306, the system 102, through a chatbot interface, prompts the user to upload relevant data, particularly in the form of at least one of: the one or more data explanation videos, the one or more process understanding videos. This step corresponds to the data obtaining subsystem 208.

At step 308, the user is presented with an interface to upload required video content, either through direct file upload or by recording a screen session. The user may choose one of the two routes: recording a live explanation or process flow (at step 310a) or uploading pre-recorded content from a local directory (step 310b). Once at least one of: the one or more data explanation videos, the one or more process understanding videos are uploaded or recorded, at step 312a or 312b, the system 102 stores the visual content for further processing. This data is used by the data extraction subsystem 210 to extract the one or more informative image frames using the one or more computer vision models and transcribe audio content using the one or more LLMs.

At step 314, the user uploads corresponding input and output format Excel files to allow the system 102 to relate the video explanations with actual data structures. This facilitates the training of the one or more AI models to understand the planning format and the logic flow, which is critical for the planning SOP generation. At step 316, the system 102 displays the generated planned SOP. This allows the user to verify whether the system 102 is correctly interpreted the planning logic and the one or more workflows based on the at least one of: the one or more data explanation videos, and the one or more process understanding videos. This visual confirmation stage supports user-guided the one or more AI models refinement.

At step 318, the user is prompted to validate the system-generated planed SOP. The system 102 checks whether the planned SOP aligns with the user's expectations and the logic explained in the video. If the planned SOP is not accurate, the user is provided with the opportunity to amend it. At step 320, the user is allowed to modify the SOP using natural language prompts, either through at least one of: the generative AI environment and the conversational interface. This modification capability is supported by the data analysis subsystem 212 and the prompts receiving subsystem 216. At step 322, if the planned SOP is accepted as accurate by the user, the new workflow is finalized and saved. This results in the creation of a standardized, reusable planning and scheduling procedure that is optimized through the system's understanding of operational logic.

Alternatively, the user may also choose to use an existing workflow at step 328. In that case, the system 102 displays the one or more workflows stored in a hierarchical tabbed structure, with each tab representing a different use case (e.g., Tab 1: Use Case 1, Tab 2: Use Case 2, etc.). The one or more workflows may be reused or modified independently, supporting scalability across multiple operational scenarios. At step 324, if an existing workflow is selected, the user can click on “Workflow Edit” to make changes. Following this, at step 326, the user may further refine the workflow by accessing the SOP editor. This leads to step 330, where the chatbot asks for a new input Excel sheet if validation or updates are required. At step 332, the user uploads the new Excel sheet, which serves as updated input data. The system 102 processes this new sheet and generates corresponding output sheets based on the modified or newly generated planned SOP using the one or more domain-specific generative AI agents. At step 334, the final output Excel sheets are displayed with the optimised operation planning and scheduling output. The output represent the result of the optimized planning and scheduling output as derived from the AI-processed SOP and constrained operational planning data. This step reflects the execution of the data processing subsystem 218.

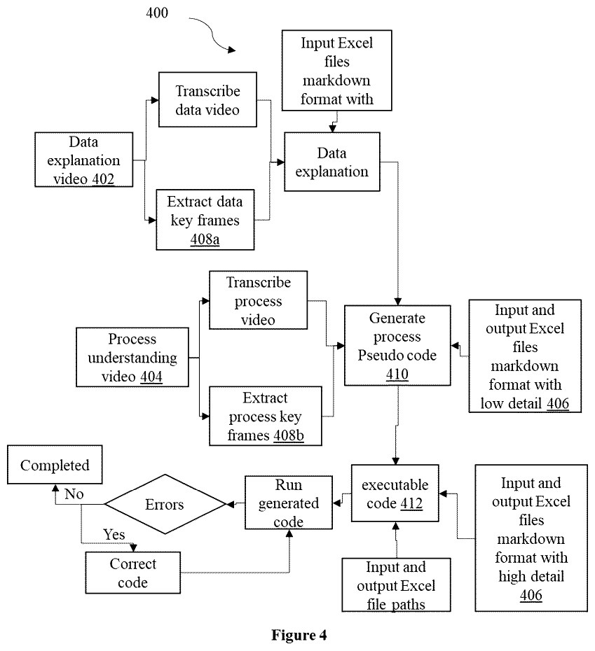

FIG. 4 illustrates an exemplary high level tech architecture 400 of the AI-based system 102, in accordance with an embodiment of the present invention.

In an exemplary embodiment, the high level tech architecture 400 is disclosing a video and file processing pipeline. The system 102 is configured to process the one or more data explanation videos 402 and the one or more process understanding videos 404 through the data extraction subsystem 210, wherein the one or more informative image frames (data key frames 408a and process key frames 408b) are extracted using the one or more computer vision models. The one or more informative image frames are selected based on significant scene transitions using the visual similarity threshold. Alongside this, the associated audio data is extracted and transcribed into text format using the speech-to-text engine integrated with the one or more LLMs. The transcription captures narrated planning logic, including task sequences, constraints, and prioritization rules explained by the user.

The extracted one or more informative image frames and the audio data are then processed by the data analysis subsystem 212, which employs at least one of the one or more VLMs and one or more LLMs to interpret visual structures (e.g., spreadsheet layouts, formula references) and verbal explanations (e.g., business rules, dependencies, manual heuristics). This analysis is combined with metadata derived from the input and output Excel files 406, such as markdown-style summaries, cell references, column headers, and file path descriptors.

Based on the combined multimodal input, including the extracted logic, spreadsheet metadata, and associated SOP context, the data analysis subsystem 212 generates a structured representation of the planning workflow. This representation is initially created as pseudo-code 410 reflecting the sequence of planning instructions and business logic. The pseudo-code 410 is then automatically translated into executable code 412 that may be invoked by the system 102 during workflow execution.

The generated executable code 412 is automatically validated through internal simulation tests or execution trials by the data processing subsystem 218. In the event of execution errors or violations of constraints, the system 102 engages the continuous feedback loop, which may invoke revisions to the SOP or refinement of the code logic. If the output passes validation, the planning logic is marked as complete and incorporated into the workflow creating subsystem 206 for scheduling automation.

The final output comprises executable code 412 that automates one or more operation planning and scheduling procedures, including but not limited to: resource allocation, material requirement forecasting, shift planning, and dispatch scheduling. The executable code 412 is stored in association with the workflow, enabling repeatable, traceable, and human-editable planning execution via AI-guided interfaces.

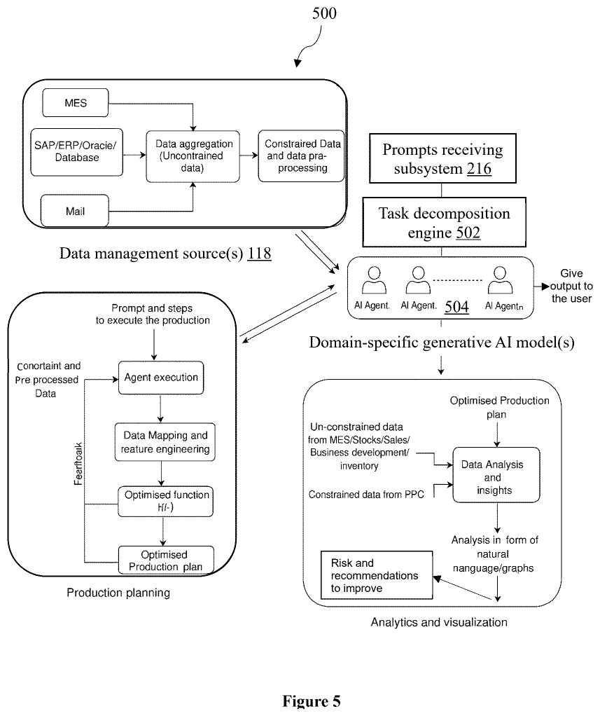

FIG. 5 illustrates an exemplary schematic diagram 500 of agentic workflow for the one or more prompts from the user, in accordance with an embodiment of the present invention.

In an exemplary embodiment, the system 102 is configured to obtain the one or more prompts, the constrained operational planning data, and at least one of: the one or more data explanation videos, and the one or more process understanding videos, as an input to generate the optimised operation planning and scheduling output. The data obtaining subsystem 208 is configured to obtain the unconstrained operational planning data from the one or more data management sources 118 an aggregate unconstrained data. The data pre-processing subsystem 214 is configured to pre-processing the unconstrained operational planning data to generate the constrained operational planning data through at least one of: the normalisation, the feature engineering, and the context-aware data transformation. The constrained operational planning data is transferred to one or more AI agents 504, each configured as the domain-specific generative AI agent(s). Similarly, the one or more prompts and at least one of: the one or more data explanation videos, and the one or more process understanding videos are assigned to the one or more AI agents 504 by the task decomposition engine 502 for parallel execution. The task decomposition engine 502 is configured with an orchestrator module, which is configured to retrieve the segregated data to orchestrate as a unified data to present to the user in a natural language format through the user interface subsystem 222. The optimized plan is analysed to produce natural language insights, graphs, charts, and dashboards. The insights are generated from the constrained operational planning data and the one or more prompts. Further, the system 102 is configured to provide risk indicators and recommendations to improve plans or avoid bottlenecks. The user is able to interact with these insights using natural language. The system 102 generates actionable analytics for decision-making and continuous improvement.

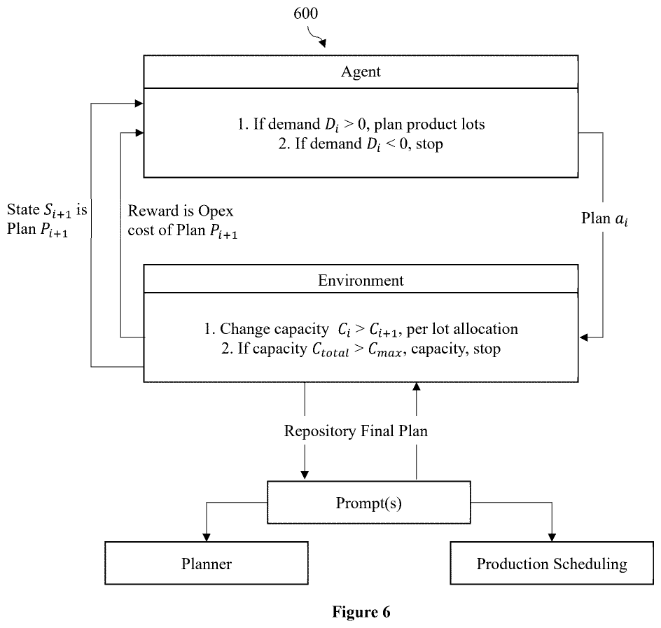

FIG. 6 illustrates an exemplary a flowchart diagram 600 for generating the optimised operation planning and scheduling output using generative AI-based agentic models, in accordance with an embodiment of the present invention.

In an exemplary embodiment, the flowchart diagram 600 illustrates the dynamic interaction between an agent and an environment in the context of operation planning and scheduling. The agent, in some aspects, may be an AI-based agent capable of making decisions and taking actions based on the current state of the environment. The environment, on the other hand, may represent the manufacturing operations, including the current production plan, machine status, material availability, and other relevant factors.

The main components of the flowchart diagram 600 that depicts the reinforcement learning model are the agent, the environment, a planner, the prompt, and the production scheduling. The agent is a core decision-maker. The agent checks demand (Dᵢ). If the demand exists, the agent plans production lots. If no demand, the agent stops. The environment represents the production system's constraints. The environment adjusts capacity (C) based on the allocated lots. The environment monitors if total capacity (Cₜₒₜₐₗ) exceeds the maximum (Cₘₐₓ) and halts if necessary. The planner plays a human role that interfaces with the system 102.

The prompt represents an interaction point, potentially for the planner to review and trigger the plan. This includes: a) please make the production plan for next week, b) generate the weekly plan based on the monthly demand, c) plan the FG codes at a 10% lower capacity considering machine breakdown, and d) FG Code raw materials that are not available and have not been updated. Please update & replan. The production scheduling executes the final plan, depicted by a factory assembly line icon.

The flowchart diagram 600 begins with the agent selecting actions, denoted as (aᵢ), based on a condition. If the number of actions is less than or equal to “n” (wherein the “n” defines a plurality of actions), the agent continues to select actions; otherwise, it stops. The actions selected by the agent may include adjustments to the production schedule, allocation of resources, or other operational decisions aimed at optimizing the production process. The reward (rᵢ) for each action is the manufacturing head (MH) cost of the plan (P_{{i+1}}), which represents the cost associated with implementing the production plan resulting from the action (aᵢ). In some cases, the system 102 may use Reinforcement Learning for production scheduling, where the agent learns to select the actions that maximize the reward over time.

The environment changes the plan (Pᵢ) to (P_{{i+1}}) per action (aᵢ) and tests the plan (P_{{i+1}}) in a simulation. The state (S_{{t+1}}) is defined as the plan (P_{{i+1}}). This iterative process allows the system to continuously refine the production plan based on the outcomes of the actions taken by the agent. The initial plan (P₀) is fed into the environment, and through iterative actions and testing, a final plan (P_{{n}}) is produced. This final plan represents the optimized production plan that minimizes the MH cost while meeting the production requirements and constraints.

At the bottom of the flowchart diagram 600, the MH manager interacts with a Plan repository, which stores the plans. The final plan is then directed towards the Factory for implementation. This represents the practical application of the optimized operation plan in the actual manufacturing operations. The implementation of the plan may involve scheduling production tasks, allocating resources, managing inventory, and other operational activities based on the decisions made by the agent. This process ensures that the production operations are aligned with the optimized plan, thereby enhancing production efficiency and reducing costs.

To optimize profitability in a manufacturing plant, a policy-based algorithm for production scheduling is implemented, outperforming the commonly used Mixed-Integer Linear Programming (MILP) model. Furthermore, by integrating a time-series neural network like transformers, and Large Language Models like Llama3, Mistral 8*7B, one or more VLMs, and the like, the model displayed greater flexibility in responding to inputs and operated more efficiently, thereby minimizing tardiness.

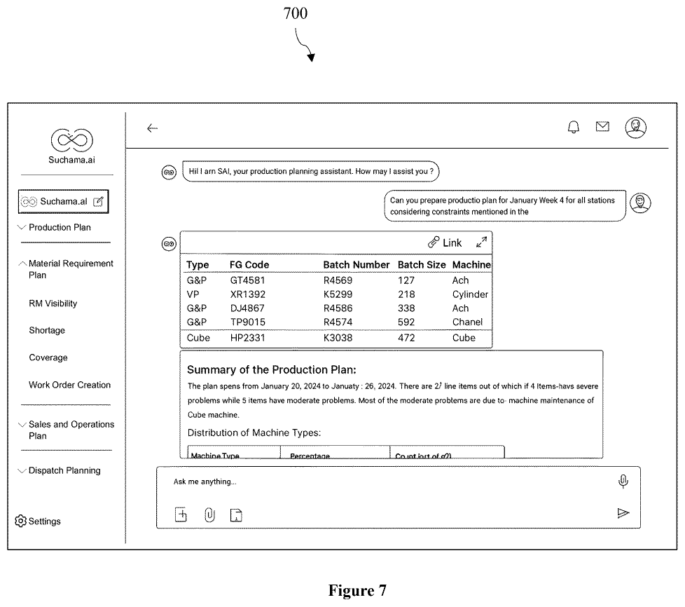

FIG. 7 illustrates an exemplary dashboard interface 700 of the AI-based system 102 product workflow for generating the optimised operation planning and scheduling output, in accordance with an embodiment of the present invention.

In an exemplary embodiment, the dashboard interface 700 provides a comprehensive view of the production process, facilitating user interaction and decision-making. In some aspects, the dashboard interface 700 may include various metrics and visual elements that provide real-time insights into the production process. These metrics and visual elements may be presented in a user-friendly and intuitive manner, allowing stakeholders to easily understand and interpret the information.

The dashboard interface 700 is part of the user interface subsystem 222 and operates in conjunction with other subsystems including the workflow creating subsystem 206, the data processing subsystem 218, and the root cause explanation subsystem 220. At the top of the dashboard interface 700, a conversational agent, integrated with the prompts receiving subsystem 216, greets the user and accepts free-form natural language prompts. In the example embodiment, the user issues a planning request prompt: “Can you prepare production plan for January Week 4 for all stations considering constraints mentioned in the . . . ”. This prompt is processed by the one or more domain-specific generative AI agents associated with the data processing subsystem 218, and parsed into sub-tasks using the task decomposition engine 502. The generated optimised operation planning and scheduling output is presented in the central panel of the dashboard interface 700. The central panel displays the production schedule output in a tabular format, which includes the following structured data fields derived from the planning SOP and constrained operational planning data: type, finished goods (FG) code, batch number, batch size, and assigned machine. These fields represent task-to-resource assignments computed through the system's optimised function, which factors in constraints such as machine availability, batch sizing logic, and resource prioritization derived from the user-defined SOP and historical performance data. Beneath the table, a “Summary of the Production Plan” section is displayed, generated via the root cause explanation subsystem 220 in conjunction with the LLM-based natural language generation module. The summary narrates the planning timeline (e.g., Jan. 20, 2024 to Jan. 26, 2024), and provides diagnostic insights on the number of problematic items, categorized into severe and moderate issues. It also explains the root cause (e.g., “machine maintenance of Cube machine”)—part of the system's multi-level causal trace. The “Distribution of Machine Types” panel further breaks down machine usage percentages and counts, supporting transparency and visual analysis. These insights are provided as part of the explainable AI functionality of the system and may be colour-coded in the full UI to reflect system status (e.g., red for constraints, green for available resources), although colour is not shown in the FIG. 7. Navigation on the left sidebar includes access to additional AI-generated planning outputs for: material requirement plan, rm visibility, shortage, coverage, work order creation, sales and operations plan, and dispatch planning. Each section reflects access points to modules within the workflow created and managed by the workflow creating subsystem 206, including the operation planning module 206a, material requirement planning module 206b, sales and operations planning module 206c, and dispatch planning module 206d.

In some cases, the dashboard interface 700 may include supplier compliance data, warehouse-specific data, and inventory days of supply. For instance, the supplier compliance data may include the number of approved suppliers, the percentage of contracts, and the percentage of non-compliant suppliers. This data may provide insights into the reliability and performance of the suppliers, aiding in supplier management and procurement decisions.

The warehouse-specific data may include the stockout rate, return rate, and backorder rate, along with detailed figures on items out of stock, in stock, returned, ordered units, backorders, and total orders. This data may provide insights into the inventory status and warehouse operations, aiding in inventory management and logistics decisions.

The inventory days of supply may be presented in the form of a graph, showing trends over time. This graph may provide insights into the inventory turnover and demand patterns, aiding in demand forecasting and production planning decisions.

In addition to these metrics and visual elements, the dashboard interface 700 may also facilitate user interaction through the agentic model, example prompts, and natural language queries. The users may add review prompts and content around active feedback and review by planner using an agentic model interface. For instance, the dashboard interface 700 may include an interactive element labelled “Ask me anything,” allowing users to input the one or more prompts (in another embodiment, prompts may be queries too) to receive specific information or perform actions. This feature may enhance user interaction and decision-making capabilities, allowing stakeholders to easily access and utilize the information presented on the dashboard interface 700.

In some aspects, the dashboard interface 700 may be part of the system's End-to-End Visualization capabilities. These capabilities may include interactive dashboards, data analytics, and customizable views, providing a comprehensive and intuitive view of the production process. By leveraging these visualization capabilities, stakeholders may gain insights into production efficiency, cost management, and performance metrics, thereby enhancing decision-making and operational efficiency. The dashboard interface 700 facilitates better communication and collaboration among different departments and stakeholders. The user may customize their view to focus on specific aspects of production process including supply-chain logistics, workforce management, quality control, and the like.

In some aspects, the system 102 may employ various optimization techniques to facilitate comprehensive planning capabilities, dynamic plan updates, and data analysis and insights. These optimization techniques may include constraint optimization, and reinforcement learning.

Constraint optimization is another technique used to optimize an objective function subject to constraints. In the context of operation planning and scheduling output, the constraint optimization may be used to balance multiple constraints such as shift schedules, raw material and packaging material availability, backorders, current production plans, and bills of materials for parts. For instance, the system 102 may use constraint optimization to adjust the production schedule based on real-time constraints, backlog, machine downtime, and changes in business requirements, thereby ensuring that the production operations remain aligned with the current conditions and priorities.

The reinforcement learning is a type of machine learning technique where an agent learns to make decisions by interacting with an environment. In the context of production planning and scheduling, reinforcement learning may be used to continuously refine the production plan based on the outcomes of the actions taken by the agent. For instance, the system 102 may use reinforcement learning to select the actions that maximize the reward over time, thereby optimizing the production schedule and resource allocation.

The system 102 employs optimization techniques including the constraint optimization, and the reinforcement learning with human feedback to generate an optimized production plan based on manshift, raw material and packaging material availability, backorder, current production plan, bill of material for the parts and the like.

In some cases, the system 102 may use these optimization techniques to adjust the production plan based on changes in demand or supply conditions. For instance, if there is a sudden surge in demand at a particular demand point, the system 102 may use these optimization techniques to quickly adjust the production schedule and resource allocation to meet the increased demand while minimizing costs. Similarly, if there is a disruption in supply from a particular plant, the system 102 may use these optimization techniques to adjust the material part flow from the other plant to meet the demand at the demand points, thereby minimizing the impact of the supply disruption on the overall production process. Also, the system 102 is configured to provide optimal overall equipment effectiveness (OEE). The system 102 is configured to increase an intellectual bandwidth and the productivity.

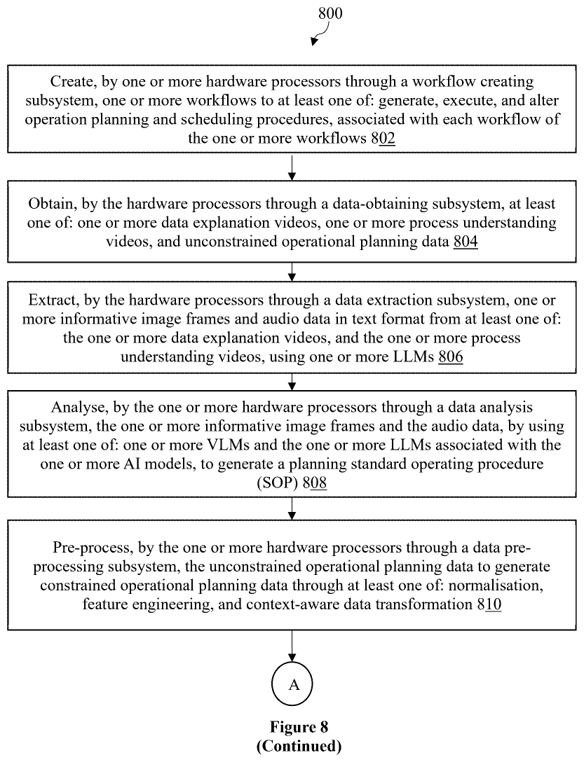

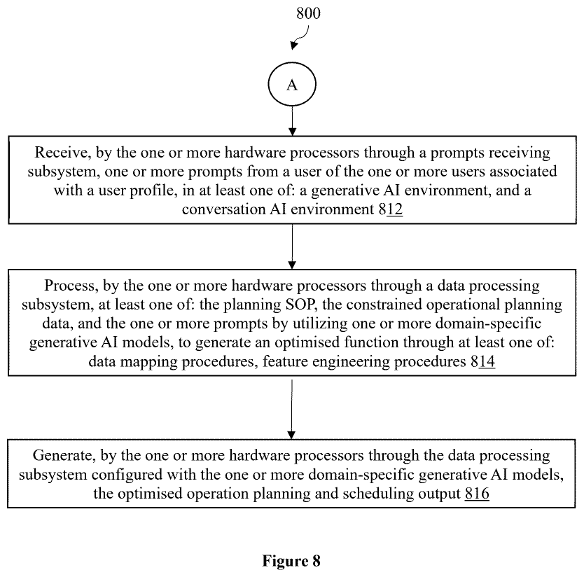

FIG. 8 illustrates an exemplary flowchart of an AI-based method 800 for generating the optimised operation planning and scheduling output, in accordance with an embodiment of the present invention.

According to another exemplary embodiment of the disclosure, the AI-based method 800 for generating the optimised operation planning and scheduling output is disclosed. At step 802, the AI-based method 800 involves the creation of the one or more workflows using the workflow creating subsystem 206 operated by the one or more hardware processors 110. The one or more workflows are configured to perform tasks related to operation planning and scheduling. The tasks may include, but not limited to, at least one of: generating the operation planning and scheduling procedures, executing the operation planning and scheduling procedures in a structured manner, and altering the generated operation planning and scheduling procedures based on updated inputs, changing operational requirements, the data querying, the why-why analysis, and user feedback. This enables dynamic and flexible workflow management, allowing the system 102 to adapt the planning and scheduling processes as needed to meet real-time business demands and optimization goals.

At step 804, the AI-based method 800 includes obtaining, by the one or more hardware processors 110 through the data obtaining subsystem 208, various types of input data necessary for generating optimized operation planning. The input data includes at least one of: the one or more data explanation videos, the one or more process understanding videos, and the unconstrained operational planning data. The input data are retrieved from at least one of: the one or more cloud storage services, the one or more end devices associated with the one or more users, and the one or more data management sources. This broad and flexible data acquisition capability ensures that the system 102 may gather relevant planning context from multiple formats and sources.

At step 806, the AI-based method 800 includes extracting, by the one or more hardware processors 110 through the data extraction subsystem 210, specific content from video-based inputs to support intelligent planning. This involves identifying and extracting the one or more informative image frames from at least one of: the one or more data explanation videos, and the one or more process understanding videos, through the one or more computer vision models. The one or more informative image frames represent key moments and visual transitions relevant to understanding the planning context. Additionally, the AI-based method 800 extracts the audio data associated with the one or more informative image frames and converts the audio data into the text format using the one or more LLMs. This dual extraction of visual and textual data enables the system 102 to capture both what is being shown and what is being explained, thereby enriching the contextual understanding needed for generating accurate and effective planning outputs.

At step 808, the AI-based method 1100 includes analysing, by the one or more hardware processors 110 through the data analysis subsystem 212, the extracted one or more informative image frames and the corresponding audio data. This analysis is performed using at least one of: the one or more VLMs that may understand and interpret visual elements in context with textual information, and the one or more LLMs that process and understand the natural language. These one or more AI models work together to derive meaningful insights from the visual and the audio data of the videos. Based on this analysis, the system 102 generates the planning SOP, which captures the key steps, rules, constraints, and logic used in the planning process. The SOP serves as a structured and AI-understandable guideline and a user-understandable guideline for further operation planning and scheduling.

At step 810, the AI-based method 800 includes pre-processing, by the one or more hardware processors 110 through the data pre-processing subsystem 214, the unconstrained operational planning data to generate the constrained operational planning data suitable for AI-driven planning. This transformation involves at least one of the following techniques: the normalisation, the feature engineering, and the context-aware data transformation, which adapts the data based on specific planning contexts such as time horizons, resource types, and operational constraints. The resulting constrained operational planning data ensures consistency, relevance, and usability for subsequent analysis and optimization processes.

At step 812, the AI-based method 800 includes receiving, by the one or more hardware processors 110 through the prompts receiving subsystem 216, the one or more prompts from the user associated with the specific user profile. The one or more prompts are received in at least one of the following environments: the generative AI environment and the conversational AI environment. The one or more prompts are related to operation planning, allowing the system 102 to incorporate user input into the decision-making and optimization process dynamically.

At step 814, the AI-based method 800 includes processing, by the one or more hardware processors 110 through the data processing subsystem 218, at least one of the following inputs: the planning SOP, the constrained operational planning data, and the one or more prompts. This processing is carried out using the one or more domain-specific generative AI agents tailored to operation planning tasks. The one or more domain-specific generative AI agents are configured to generate the optimized function that forms the basis for producing efficient and context-aware planning and scheduling outputs through at least one of: the data mapping procedures and the feature engineering procedures.

At step 816, the AI-based method 800 includes generating, by the one or more hardware processors 110 through the data processing subsystem 218 configured with the one or more domain-specific generative AI agents, the optimised operation planning and scheduling output. The optimised operation planning and scheduling output is generated based on the previously generated optimised function. The system 102 is equipped with the continuous feedback loop that enables real-time adaptation of the optimized function. This dynamic adjustment occurs in response to at least one of: the one or more prompts requesting changes and insights, amended planning SOP, and real-time changes in the constrained operational planning data. This ensures that the generated planning and scheduling output remains relevant, accurate, and responsive to evolving operational conditions.

Numerous advantages of the present disclosure may be apparent from the discussion above. In accordance with the present disclosure, the system 102 enable the automated generation of operational planning and scheduling workflows based on user-defined logic without requiring complex programming or rigid rule templates. The system 102 allow enterprise users to configure and teach planning logic using non-traditional, multimodal inputs such as screen recordings, narrated explanations, and unconstrained planning data. The system 102 facilitate the processing and transformation of both structured and unstructured data sources including Excel files, ERP system outputs, emails, and document attachments into machine-readable, constraint-compliant formats suitable for optimisation.

The system 102 is configured to provide a dynamic and interactive planning interface where the one or more users are able to modify or query planning logic and outcomes using natural language inputs in a generative or conversational AI environment. To support the use of the one or more AI models, including domain-specific LLMs, the one or more VLMs, and the task-decomposing agent, for parsing, executing, and optimizing enterprise planning tasks. To enable continuous learning and iterative refinement of planning models and workflows based on user feedback, execution results, and real-time changes in operational data. To offer root-cause traceability of planning anomalies or failures through multi-level the “why-why” analysis, enabling explainable AI-based decision support in planning environments. To deliver end-to-end automation of production, material, and dispatch planning through an extensible, the system architecture deployable in real-world industrial or supply chain environments.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/We claim:

1. An artificial intelligence-based (AI-based) method for generating optimised operation planning and scheduling output, comprising:
creating, by one or more hardware processors through a workflow creating subsystem (206), one or more workflows configured to at least one of: generate and execute operation planning and scheduling procedures, and alter the generated operation planning and scheduling procedures, associated with each workflow of the one or more workflows;
obtaining, by the one or more hardware processors through a data obtaining subsystem, at least one of: one or more data explanation videos, one or more process understanding videos, and unconstrained operational planning data, from at least one of: one or more cloud storage services, one or more end devices associated with one or more users, and one or more data management sources;
extracting, by the one or more hardware processors through a data extraction subsystem, at least one of:
one or more informative image frames from at least one of: the one or more data explanation videos, and the one or more process understanding videos, through one or more computer vision models; and
audio data associated with the one or more informative image frames, in a text format, from at least one of: the one or more data explanation videos, and the one or more process understanding videos, using one or more large language models (LLMs) associated with one or more artificial intelligence (AI) models;
analysing, by the one or more hardware processors through a data analysis subsystem, the one or more informative image frames and the audio data, by using at least one of: one or more visual language models (VLMs) and the one or more large language models (LLMs) associated with the one or more artificial intelligence (AI) models, to generate a planning standard operating procedure (SOP);
pre-processing, by the one or more hardware processors through a data pre-processing subsystem, the unconstrained operational planning data to generate constrained operational planning data through at least one of: normalisation, feature engineering, and context-aware data transformation;
receiving, by the one or more hardware processors through a prompts receiving subsystem, one or more prompts from a user of the one or more users associated with a user profile, in at least one of: a generative artificial intelligence (AI) environment, and a conversation artificial intelligence (AI) environment;
processing, by the one or more hardware processors through a data processing subsystem, at least one of: the planning standard operating procedure (SOP), the constrained operational planning data, and the one or more prompts by utilizing one or more domain-specific generative artificial intelligence (AI) agents, to generate an optimised function through at least one of: data mapping procedures and feature engineering procedures; and
generating, by the one or more hardware processors through the data processing subsystem configured with the one or more domain-specific generative artificial intelligence (AI) agents, the optimised operation planning and scheduling output based on the optimised function with a continuous feedback loop configured to adapt the optimised function in response to at least one of: the one or more prompts, amended planning standard operating procedure (SOP), and real-time changes in the constrained operational planning data.

2. The artificial intelligence-based (AI-based) method as claimed in claim 1, wherein each workflow of the one or more workflows comprises a plurality of modules,
the plurality of modules comprises at least one of: an operation planning module (206a), a material requirement planning module (206b), a sales and operations planning module (206c), and a dispatch planning module (206d), configured with the one or more domain-specific generative artificial intelligence (AI) agents, for at least one of:
generating resource-aware production schedules to optimise an allocation of at least one of: manpower, machines, market demand, production calendar, and material usage over a defined time horizon;
computing and scheduling a procurement and availability of materials required for operations;
reconciling demand forecasts and sales objectives with production and material constraints to generate medium-to-long-term sales and operations planning (S&OP) outputs; and
generating dispatch plans based on finished goods availability, delivery schedules, customer service levels, and logistics constraints.

3. The artificial intelligence-based (AI-based) method as claimed in claim 1, wherein,
the one or more data explanation videos comprise at least one of: a recorded narration explaining at least one of: structure, purpose, and semantic meaning of one or more input and output files used in the operation planning and scheduling procedures, a walkthrough of column headers, data formats, and inter-sheet dependencies, and at least one of: a visual and a verbal description of uploaded data relates to production planning variables including inventory, manpower, and machine availability;
the one or more process understanding videos comprise at least one of: a recorded screen interaction demonstrating the step-by-step execution of a planning workflow, a voice-narrated explanation of at least one of: business logics, constraints, and rules applied during manual planning, and a visual representation of decisions made during planning, comprising at least one of: sequencing, priority handling, and bottleneck resolution; and
the unconstrained operational planning data comprises at least one of: production data, planning and transactional data, and unstructured communication data.

4. The artificial intelligence-based (AI-based) method as claimed in claim 1, wherein
extracting, by the one or more computer vision models, the one or more informative image frames by determining momentous scene transitions based on a visual similarity threshold; and
transcribing, by a speech-to-text engine associated with the one or more large language models (LLMs), the audio data to identify domain-specific vocabulary based on the context of the at least one of: the one or more data explanation videos, and the one or more process understanding videos.

5. The artificial intelligence-based (AI-based) method as claimed in claim 1, wherein
amending, by the one or more users through the data analysis subsystem, the generated planning standard operating procedure (SOP) by using natural language instructions in at least one of: the generative artificial intelligence (AI) environment, and the conversation artificial intelligence (AI) environment, to update the operation planning and scheduling output.

6. The artificial intelligence-based (AI-based) method as claimed in claim 1, wherein the one or more prompts comprise at least one of:
requesting one of: generation and regeneration of an operational plan based on at least one of: the planning standard operating procedure (SOP) and the constrained operational planning data;
an instruction to amend the planning standard operating procedure (SOP), including at least one of: production quantity, shift timing, resource allocation, and priority rules;
a request to simulate alternate planning scenarios based on hypothetical changes in one of: demand, supply, and capacity;
a query for at least one of: insights, justifications, and root-cause explanations related to the generated optimised operation planning and scheduling output.

7. The artificial intelligence-based (AI-based) method as claimed in claim 1, wherein the one or more domain-specific generative artificial intelligence (AI) agents comprise a task decomposition engine,
the task decomposition engine is configured to split at least one of: the planning standard operating procedure (SOP), the constrained operational planning data, and the one or more prompts, into multiple subtasks and distribute the multiple subtasks to each domain-specific generative artificial intelligence (AI) agent of the one or more domain-specific generative artificial intelligence (AI) agents for parallel execution.

8. The artificial intelligence-based (AI-based) method as claimed in claim 1, wherein the optimised function comprises at least one of: a multi-variable, constraint-aware optimisation model configured to generate the optimised operation planning and scheduling output based on inputs including at least one of: source availability data, demand forecasts data, inventory levels data, and personnel shifts data, in at least one of: the planning standard operating procedure (SOP), and the constrained operational planning data.

9. The artificial intelligence-based (AI-based) method as claimed in claim 1, wherein
generating, by the one or more hardware processors through a root cause explanation subsystem, a multi-level causal trace for each identified task in the optimised operation planning and scheduling output through one or more problem-solving procedures; and
presenting, by the one or more hardware processors through a user interface subsystem, at least one of: the optimised operation planning and scheduling output, and a natural language explanation of the multi-level causal trace and one or more recommended corrective actions with one or more colour coding,
the optimized operational planning and scheduling output include generation of at least one of: a production schedule by time slot and resource allocation, material procurement planning, shift-wise workforce allocation planning, and dispatch planning and delivery scheduling.

10. The artificial intelligence-based (AI-based) method as claimed in claim 1, wherein the one or more domain-specific generative artificial intelligence (AI) agents are trained and retrained through a continuous training loop subsystem,
the continuous training loop subsystem, comprising:
capturing, by the one or more hardware processors, one or more user interactions with at least one of: the planning standard operating procedure (SOP), the one or more workflows, and the optimised operation planning and scheduling output, including natural language modifications and feedback;
updating, by the one or more hardware processors, the one or more domain-specific generative artificial intelligence (AI) agents based on at least one of: task outcomes, success rates, execution accuracy, and user alterations;
storing, by the one or more hardware processors, in a learning repository, at least one of: amended planning standard operating procedures (SOPs), prompt-response pairs, and associated planning outcomes as training data; and
retraining, by the one or more hardware processors, the one or more domain-specific generative artificial intelligence (AI) agents by using the stored training data to generation the optimized operation planning and scheduling output over time.

11. An artificial intelligence-based (AI-based) system for generating optimised operation planning and scheduling output, comprising:
one or more servers, comprising:
one or more hardware processors; and
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a workflow creating subsystem configured to create one or more workflows to at least one of: generate and execute operation planning and scheduling procedures, and alter the generated operation planning and scheduling procedures, associated with each workflow of the one or more workflows;
a data obtaining subsystem configured to obtain at least one of: one or more data explanation videos, one or more process understanding videos, and unconstrained operational planning data, from at least one of: one or more cloud storage services, one or more end devices associated with one or more users, and one or more data management sources;
a data extraction subsystem configured to extract at least one of:
one or more informative image frames from at least one of: the one or more data explanation videos, and the one or more process understanding videos, through one or more computer vision models; and
audio data associated with the one or more informative image frames, in a text format, from at least one of: the one or more data explanation videos, and the one or more process understanding videos (404), by using one or more large language models (LLMs) associated with one or more artificial intelligence (AI) models;
a data analysis subsystem configured to analyse the one or more informative image frames and the audio data, by using at least one of: one or more visual language models (VLMs) and the one or more large language models (LLMs) associated with the one or more artificial intelligence (AI) models, for generating a planning standard operating procedure (SOP);
a data pre-processing subsystem configured to pre-process the unconstrained operational planning data to generate constrained operational planning data through at least one of: normalisation, feature engineering, and context-aware data transformation;
a prompts receiving subsystem configured to receive one or more prompts from a user of the one or more users associated with a user profile, in at least one of: a generative artificial intelligence (AI) environment, and a conversation artificial intelligence (AI) environment; and
a data processing subsystem configured to:
process at least one of: the planning standard operating procedure (SOP), the constrained operational planning data, and the one or more prompts by utilizing one or more domain-specific generative artificial intelligence (AI) agents, to generate an optimised function through at least one of: data mapping procedures, and feature engineering procedures; and
generate the optimised operation planning and scheduling output based on the optimised function with a continuous feedback loop configured to adapt the optimised function in response to at least one of: the one or more prompts, updated planning standard operating procedure (SOP), and real-time changes in the constrained operational planning data.
